(19) United States
(12) Patent Application Publication
(10) Pub. No.: US 2025/0242564 A1
(43) Pub. Date: Jul. 31, 2025

(54) LIGHTWEIGHT SANDWICH COMPONENT WITH PARTIALLY COVERED CORE AND METHOD FOR PRODUCING A SANDWICH COMPONENT

(71) Applicant: Diehl Aviation Laupheim GmbH, Laupheim (DE)

(72) Inventors: Ralf Gerner, Burgrieden (DE); Johannes Berkenhoff, Biberach an der Riss (DE)

(21) Appl. No.: 19/039,815

(22) Filed: Jan. 29, 2025

(30) Foreign Application Priority Data
Jan. 30, 2024 (DE) 102024102509.3

(51) Int. Cl. B32B 5/06; B32B 5/12; B32B 5/18; B32B 7/08

(52) U.S. Cl. CPC B32B 5/06; B32B 5/12; B32B 5/18; B32B 7/08; B32B 2307/516; B32B 2605/18

(57) ABSTRACT

A sandwich component includes a core having two opposite flat sides and at least one first cover layer connected to the core, mechanically stabilizing the sandwich component and containing at least one fiber component containing fibers. At least one of the flat sides is coated with the first cover layer such that only a coating region of this side is covered by the first cover layer, so that an uncoated free region of this flat side remains, and this flat side is not coated with any further layers so that the core is accessible from an environment in the free region on this flat side. A method for producing a sandwich component includes providing the core, and coating at least one of the flat sides with the first cover layer such that the core remains accessible from the environment in the free region on this flat side.

### CROSS-REFERENCE TO RELATED APPLICATION

This application claims the priority, under 35 U.S.C. § 119, of German Patent Application DE 10 2024 102 509.3, filed Jan. 30, 2024; the prior application is herewith incorporated by reference in its entirety.

### FIELD AND BACKGROUND OF THE INVENTION

The invention relates to a sandwich component, in particular one that is intended for use in an interior of an aircraft, in particular of an eVTOL (electrical vertical take-off and landing vehicle).

Canadian Patent CA 2,138,775 C, corresponding to U.S. Pat. Nos. 5,624,622 and 5,741,574, discloses a reinforced sandwich structure with a foam core, which includes opposite cover layers, a foam core between them and tow elements, which are encapsulated in the foam core, extend between the opposite cover layers and form a supporting structure inside the foam core between the cover layers.

### SUMMARY OF THE INVENTION

It is accordingly an object of the invention to provide a lightweight sandwich component with a partially covered core and a method for producing a sandwich component, which overcome the hereinafore-mentioned disadvantages of, and provide improvements relative to, the heretofore-known components and methods of this general type.

With the foregoing and other objects in view there is provided, in accordance with the invention, a sandwich component having a core which includes two opposite flat sides, at least one first cover layer which is connected to the core, mechanically stabilizes the sandwich component and contains at least one fiber component that contains fibers, at least one of the flat sides is coated with the first cover layer in such a way that only a coating region of this side is covered by the first cover layer, so that an uncoated free region of this flat side remains, and this flat side is not coated with any further layers so that the core is accessible from the environment or surroundings in the free region on this flat side.

Preferred or advantageous embodiments of the invention and other categories of the invention may be found in the further claims, the following description and the appended figures.

The sandwich component is in particular an internal component of an aircraft. The aircraft is in particular an airplane, in particular a light aircraft, in particular an eVTOL. In other words, the sandwich component is in particular intentionally effected or adapted as an internal component for the corresponding aircraft.

The sandwich component contains a core. The core has two opposite flat sides. The core therefore extends flatly, that is to say it is a flat component. The area of the flat sides is therefore in particular substantially (orders of magnitude) greater than the rest of the surface of the core, that is to say its marginal faces. The core is in particular a honeycomb core or a foam core.

The term “flat side” is to be interpreted broadly, and is merely intended to mean that it is one of the two comparatively large-area main faces of the core and specifically not its lateral/end, comparatively small-area edges/edge faces. The flat sides need in no way be planar, but may also extend with a curvature/angulation/etc. In other words, it may also be a core of a curved panel/sandwich component.

The sandwich component contains at least one first cover layer. The first cover layer is connected to the core. The first cover layer is a cover layer that mechanically stabilizes the sandwich component, or the core. The first cover layer contains at least one fiber component. The fiber component contains fibers. The fibers are in particular glass fibers or carbon fibers. The fiber component is configured in particular as a prepreg, as is usual for sandwich interior components in aviation. “Connected” is to be interpreted as meaning for example adhesively bonded or consolidated in a thermoforming process, as is usual for such sandwich components.

At least one of the flat sides of the core is coated with, i.e. connected to and partially covered by, the first cover layer or one of the first cover layers. Such coating of the relevant flat side with the first cover layer takes place in such a way that: only a coating region (one or more surface sections of the flat side) of this flat side is covered by the first cover layer. This means that a free region (likewise one or more surface sections) remains on this flat side, or the core. The core is thus not coated by the first cover layer in the free region. It coats the core only in the coating region. The relevant flat side is also not coated by any further layer, in particular any further supporting layer. In particular, the relevant flat side is thus not coated by any layer. The effect of this is that the core is, or remains, accessible from the environment of the sandwich component in the free region on this flat side. The core would thus be visible to an observer of the relevant flat side in the free region. The coating region and the free region together make up the entire area of the relevant flat side.

Alternatively, the relevant flat side is not coated at least by any supporting layer. This is to be understood in the context of the present invention as “not coated”. Correspondingly, this also applies for the statement of “accessibility”. Any further layer is, for example, a pure decorative layer or a very lightweight layer without any substantial or considerable supporting function, for example purely decorative foil covering or varnishing. The only difference is that the core is no longer “visible”. In other words, the core could also be protected with a merely very lightweight layer on the “free locations” (no first cover layer there). The term “not coated” thus includes coating with a layer that is insignificant in respect of any supporting function.

Such a first cover layer may also be disposed in the same way on the second flat side, i.e. the second flat side may also be connected to/coated with a further first cover layer in this way.

According to the invention, the effect is achieved on the respective flat side coated in this way with the first cover layer (free region remains) that although mechanical stabilization of the core takes place in the coating region—namely by the fiber components—the free regions nevertheless remain uncovered. The first cover layer is therefore not a surface-wide layer. This leads to a weight saving. The coating region or regions may, however, be selected so that the mechanical strength of the sandwich component is still sufficient. For example, only load paths in the sandwich component that are to be expected during operation may be reinforced with the cover layer, whereas regions that according to experience are mechanically loaded less or not at all remain uncoated. There are therefore scarcely any disadvantages mechanically in respect of the stability, load capacity, durability, etc. compared with surface-wide coating of the respective flat side with a surface-wide cover layer as is known in the art.

In one preferred embodiment, the coating region on at least one of the flat sides occupies at least 10%—and in particular at most 50%—of the total area of the respective flat side. Particularly in the case of, for example, very small/highly stressed components, it may be assumed that the coating region could in particular increase to even more than 50%. In other words, a not insignificant part of the total area is covered by the first cover layer, that is to say it forms the coating region of this flat side. The same applies for the free region. There are therefore noticeable or even substantial weight savings compared with surface-wide coating of the respective flat side with a first cover layer.

In one preferred embodiment, at least one of the fiber components, in particular a plurality or all of the fiber components, exclusively include unidirectionally oriented fibers. “Exclusively” refers in this case to the respective proportion of fibers in the fiber component. In other words, there are no fibers other than unidirectionally/“parallel” oriented fibers in the corresponding fiber component. The fiber component is in particular a “UD fiber component” (unidirectional) with oriented fibers, for example a corresponding fiber tape in which the fibers run exclusively in the longitudinal extent direction of the tape. Such tapes are particularly suitable for the production of corresponding selective reinforcement of a flat side in the coating region with the aid of the first cover layer. In particular, they may absorb tensile forces there.

In one preferred embodiment, at least one of the fiber components, in particular a plurality or all of the fiber components, include crossed fibers. In other words, they are a textile fiber component, for example a commercially available textile prepreg. In this way, regions of the first cover layer that are made with corresponding fiber components can mechanically reinforce the core and therefore the sandwich component particularly stably. In this case, forces are absorbed in a plurality of directions.

In one preferred variant of this embodiment, at least one of the fiber components, in particular a plurality or all of the fiber components, that have crossed fibers are disposed on a margin of the respective flat side. In other words, the margin of the respective flat side on the sandwich component is thus mechanically configured to be particularly stable/load-bearing.

In one preferred variant of this embodiment, the sandwich component contains at least one mechanical coupling element which is mechanically connected firmly to the rest of the sandwich component. Such a coupling element is for example a bracket, clip, insert, etc. and is used for mechanically load-bearing connection of the sandwich component to further elements, for example a fuselage structure of an aircraft. At least one of the fiber components, in particular a plurality or all of the fiber components, that have crossed fibers are in this case assigned to the coupling element. “Assigned” means that the fiber component having crossed fibers has a mechanically reinforcing effect in relation to the mechanical attachment of the coupling element to the rest of the sandwich component. The corresponding fiber component is thus in particular disposed on the coupling element and/or immediately next to it and/or between it and the core and/or in the region of the coupling element. In particular, the relevant fiber component forms for example a surface section on the flat side which is larger than a base face of the coupling element and at the center of which the coupling element is then disposed. There is therefore a particularly stable mechanical connection between the coupling element and the rest of the sandwich component, i.e. the coupling element is mechanically attached/supported/connected sufficiently firmly on the sandwich component.

In one preferred embodiment, at least one of the fiber components, in particular a plurality or all of the fiber components, are configured in the form of tape. This applies both for fiber components having unidirectional fibers and for fiber components having crossed fibers. In other words, corresponding fiber components are laid, or applied, as tapes on the corresponding flat side of the sandwich component. Particularly expediently, a corresponding first cover layer can be formed from such tapes and free regions can be made on the flat side. In particular, load paths may be or are formed well in this way.

In one preferred variant of this embodiment, at least a part of at least one of the (one or both) first cover layers, in particular this entire first cover layer, is formed by fiber components in the form of tape, which are disposed in the shape of a framework on the respective flat side. In other words, at least two fiber components that intersect or abut overlapping form a “branch” in the framework. For example, framework structures established from building technology or other fields of mechanical engineering may be made as at least part of the coating region and may provide sufficient mechanical stability in the sandwich component by comparatively small coating regions (in proportion to the total area of the flat side).

In one preferred embodiment, at least a part of at least one of the (one or both) first cover layers, in particular this entire first cover layer, is formed in one ply in respect of the fiber components. This means that only one respective fiber component is laid at a given location of the cover layer on the corresponding flat side. “One ply” is to be interpreted as meaning that possible crossings/branching points, etc. of fiber components (for example in a framework configuration, see above) are to be excepted. In this case, two or more plies of fiber components may also be layered above one another in sections. Apart from this, however, there are no tapes or surface sections multiply layered above one another/overlapping.

In one preferred embodiment, at least a part of at least one of the (one or both) first cover layers, in particular this entire first cover layer, is formed flush with the core. In other words, the cover layer is sunk into the core at the relevant location, for example pressed with its deformation, to such an extent that there is also a smooth, i.e. discontinuity-free—in the mathematical sense with a constant derivative—and in particular bend-free surface of the entire sandwich component on the corresponding flat side. In other words, the sandwich component is thus not raised in the region of the fiber components, or the first cover layer. A smooth surface may therefore be achieved on the relevant flat side of the sandwich component, which is for example particularly appealing visually and also facilitates/enables release from a mold for producing the sandwich component.

In one preferred embodiment, at least one, in particular precisely one, of the flat sides (and therefore the core) is coated with a second cover layer. In particular, if a first cover layer is also present on this flat side, the second cover layer covers both the core and the first cover layer i.e. it forms a cover layer further away from the core than the first cover layer. Because of a corresponding second cover layer, any desired further configurations of the sandwich component may be implemented in respect of its surface. For example, the second cover layer need not in this case comply with the load paths/mechanical constraints of the second cover layer but may for example be intended/optimized for the optical appearance of the sandwich component.

In one preferred variant of this embodiment, at least one, in particular precisely one, of the flat sides is covered entirely, or surface-wide, by the second cover layer. This leads to a flat side on the sandwich component on which the core is no longer accessible from the environment, and in particular no longer visible. A corresponding flat side having the surface-wide second cover layer may therefore, for example, be made visually particularly appealing, for example varnished/foil covered.

In respect of the second layer, there is thus a coating region (in the above sense of the first cover layer) that corresponds to the entire area of the flat side, there being no free region in respect of the second layer at any location of this flat side.

In one preferred variant of this embodiment, one of the flat sides that are coated surface-wide with the second cover layer is a visible side of the sandwich component in an intended mounting state of the sandwich component. The intended mounting state is one in which the sandwich component is later to be installed in an application, for example to be fitted in an aircraft. For example, the sandwich component is an interior paneling part in an interior or cabin of an aircraft. The relevant flat side then faces towards the interior/cabin and can be seen by persons who are inside the aircraft, or in the interior/cabin.

The opposite flat side is then in particular one that is covered only by the first cover layer. Although the core is then accessible from the environment, and therefore also visible, this is not a problem since it is not a visible side in the installed state and its appearance is therefore irrelevant. The weight saving may thus particularly advantageously be achieved.

In one preferred variant of this embodiment, at least one of the second cover layers contains a foam component. In other words, this cover layer is therefore a foam layer. Foam components can be configured particularly easily as a cover layer, are also lightweight and can be surface treated, for example smoothed, varnished, etc. A visually appealing but nevertheless lightweight sandwich component may therefore be provided.

With the objects of the invention in view, there is concomitantly provided a method for producing the sandwich component according to the invention. In the method, the core of the sandwich component is provided. At least one of the flat sides of the core is subsequently coated with the first cover layer in such a way that the core remains accessible from the environment in the free region on this flat side.

According to the method, the sandwich components according to the invention are obtained.

The method and at least some of its possible embodiments, as well as the respective advantages, have already been explained mutatis mutandis in connection with the sandwich component according to the invention.

The invention is based on the following discoveries, observations or considerations, and also includes the following preferred embodiments. These embodiments will also sometimes be referred to for simplicity as “the invention.” The embodiments may also contain parts or combinations of the embodiments mentioned above or may correspond thereto and/or may optionally also include embodiments not yet mentioned.

The invention provides sandwich components having partial (prepreg) coating, or partial coating of sandwich components.

Instead of full-surface coating on the front and rear sides of the core material, only partial coating is carried out with the first cover layer (for example prepreg (UD or textile)) in order to obtain a component optimized in terms of weight and load. If required for a later decoration, the visible layer may also be provided with a complete second cover layer (prepreg ply) as previously.

A possibility for lightweight construction is thus proposed, in which coating with continuous plies is obviated at least on one flat side and the required component strength is generated by partial laying of fibers, in particular oriented fibers.

One possible application of the concept in a specific product involves, for example, interior paneling parts for airplanes or air taxis.

In particular, an ultra-lightweight construction is obtained for eVTOL interior components. Interior paneling components of aerial vehicles and/or eVTOL interior panelings are therefore provided.

Coating thus no longer takes place with complete cover plies on the front and rear sides. An open core is no longer—as is sometimes usual in the art—visible/accessible from the environment only on cut edges.

Particularly for interior trim components in airplanes, this obviates always using complete prepreg plies of textile for the production of interior trim components.

Optimized use of material is achieved by load-optimized reinforcements and a weight saving.

According to the invention, load-oriented coating takes place, but in particular not with laminates/sandwich constructions having a plurality of plies. The special feature in this case is that the material is not completely covered with a first cover layer (prepreg) on at least one flat side.

The use of a thin foam ply (second cover layer) reduces the outlay on grinding and smoothing. Alternatively or in addition, a foam core (the core itself contains foam material) may also generally be envisaged.

In particular, unidirectional fiber tapes are thus used to generate a framework on the rear side of the component, instead of cover plies employed extensively. Only 10% to 50% of the surface is covered, which means a material and weight saving of 50%-90% of the rear-side cover ply of the sandwich composite component. In particular, a part of the core material is always visible on the rear side and is not covered by an extensive ply of prepreg.

According to the invention, reinforcements are thus not (in order to form the first cover ply) layered in multiple plies on one another, but instead single-ply reinforcements are produced with tape, in particular tape reinforced with endless fibers. This is not a lattice structure that is layered in a mold, but instead the structure is achieved by the laying of fibers, in particular unidirectional fibers, and may be applied onto the core material in any desired patterns (shape/structure of the first cover layer).

In particular: the component rear side of sandwich interior paneling components is reinforced by unidirectional prepregs of glass or carbon, etc. The orientation may take place in freely selected patterns of straight webs (straight tapes, made following this surface of the component even if it is not spatially straight). In this case, either an individual load-specific/load-oriented pattern is used, or a geometrical coating optimized for a general load distribution is used. Thus, both the component weight and the use of material are minimal. The front side (visible side towards the passenger) made still be coated surface-wide with textile prepreg.

The reinforcements (first cover layer) in particular do not contribute to the thickness, but are pressed into the core material (i.e. they are then “flush” with the rest of the core); so that no release problems in the pressing process arise because of the reinforcements applied in the production process by the partial use of the tapes.

The components produced are also distinguished in particular by a textile-reinforced component margin. Furthermore, in particular, textile-reinforced patches are used in the region of the brackets.

Both honeycomb and foam substances are suitable as core materials.

Autoclave technology, vacuum technology, pressing technology with cycling temperature control as well in the hot-in/hot-out method are suitable as production methods.

Other features which are considered as characteristic for the invention are set forth in the appended claims.

Although the invention is illustrated and described herein as embodied in a lightweight sandwich component with a partially covered core and a method for producing a sandwich component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, rear-elevational view of a sandwich component;

FIG. 2 is a front-elevational view thereof, including a flowchart of its production;

FIG. 3 is a cross-sectional view thereof, taken along a line III-III in FIGS. 1 and 2;

FIG. 4 is a cross-sectional view of an alternative second sandwich component;

FIG. 5 is cross-sectional view of an alternative third sandwich component; and

FIG. 6 is a rear-elevational view of a fourth alternative sandwich component in a view according to FIG. 1.

### DETAILED DESCRIPTION OF THE INVENTION

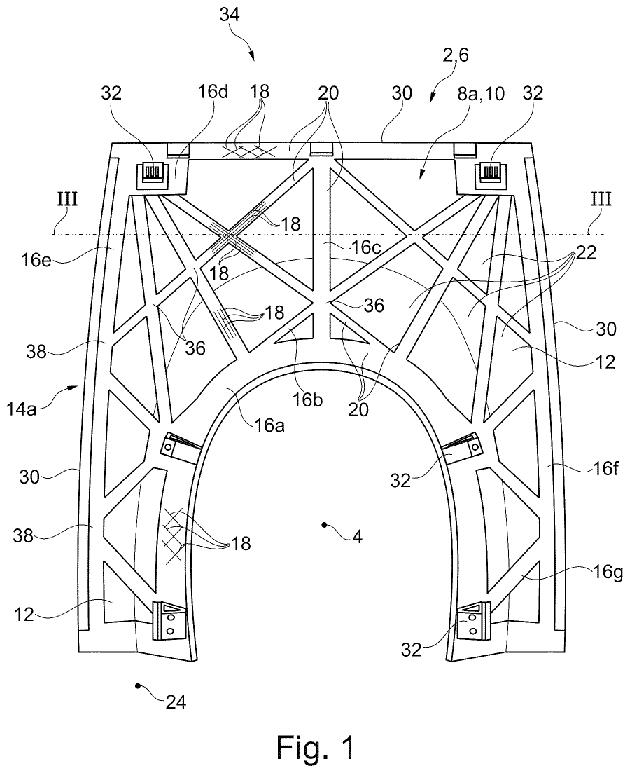

Referring now to the figures of the drawings in detail and first, particularly, to FIG. 1 thereof, there is seen a sandwich component 2 in the form of an interior component of an aircraft, in this case an eVTOL. The sandwich component 2, or the interior component, is in this case a paneling component 6 that surrounds a window 4 (not represented, or only present in the installed state). The sandwich component 2 contains a core 12, in this case a honeycomb core.

FIG. 1 shows a first flat side 8a of the core 12, in this case its rear side 10. When installed as intended in the eVTOL (not represented) this rear side faces the airplane outer wall and therefore cannot be seen by passengers who are inside the eVTOL.

The sandwich component 2 contains a first cover layer 14a, which mechanically stabilizes it. The first cover layer 14a contains a multiplicity of fiber components 16. For the sake of clarity, only a few of these are provided with reference signs in the figures. The reference sign “16” is furthermore suffixed with a lowercase letter were appropriate for distinguishability.

The first cover layer 14a is in this case a prepreg and is connected to the core 12, in this case consolidated in the usual way. The fiber components 16 are thus prepregs in this case. The fiber components 16 contain fibers 18, which are indicated only by way example and symbolically in the figure.

The flat side 8a is coated with the first cover layer 14a, i.e. connected or consolidated, in such a way that only a coating region 20 (surface section of the flat side 8a, in this case in several parts) is covered by the first cover layer 14a. An uncovered free region 22 (also a surface section of the flat side 8a, in this case in several parts) is therefore not covered by the first cover layer 14a, but instead remains uncovered. The first flat side 8a is also not coated with any further layer or other elements, so that the core 12 is accessible from an environment 24 of the sandwich component 2 in the free region 22 on this flat side 8a.

The coating region 20 thus is formed of all surface sections of the flat side 8a that are covered by all the fiber components 16. The free region 22 represents the remaining surface sections of the flat side 8a.

Some of the fiber components 16, in this case for example the fiber components 16b,c,g, exclusively include unidirectionally oriented fibers 18, i.e. they are so-called UD prepregs. Other fiber components 16, for example the fiber components 16a,d,e,f, on the other hand include crossed fibers 18, i.e. they are textile fiber components or textile prepregs.

Some of these fiber components 16 having crossed fibers 18, in this case for example the fiber components 16e,f, are disposed on the respective margin 30 of the sandwich component 2, or of the core 12.

The sandwich component 2 also contains a mechanical coupling element 32 or mechanical coupling elements 32, in this case a bracket for fastening the sandwich component in the eVTOL. Some of the fiber components 16 having crossed fibers 18, in this case for example the fiber component 16d, are assigned to these coupling elements 32, that is to say they are disposed in their region between the coupling element 32 and the core 12 in order to increase the mechanical strength of the sandwich component 2 there.

Several of the fiber components 16 are configured in the form of tape, in this case for example the fiber components 16b,c,e,f,g. These fiber components 16 in the form of tape are disposed in the shape of a framework 34 on the core 12, or the flat side 8a, i.e. the framework is formed by the fiber components 16 in the form of tape.

FIG. 1 shows as a framework 34 a load-orientedly laid unidirectional pattern made with tapes. The component marginal region (margin 30) is reinforced on the rear side 10 with textile prepreg (e.g. fiber component 16e,f).

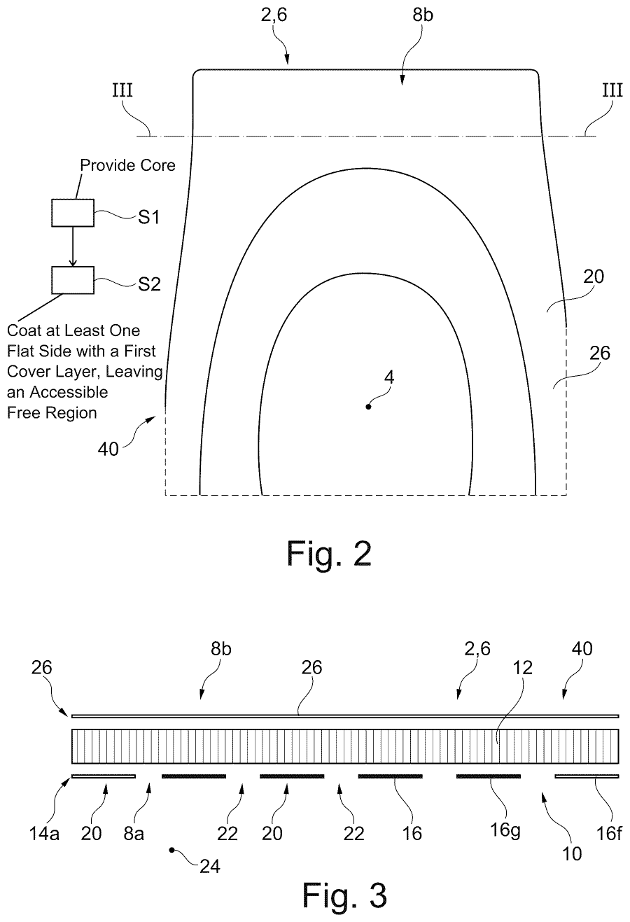

FIG. 2 shows the sandwich component 2 of FIG. 1, but in this case from the other viewing direction, and therefore the flat side 8b of the core 12. The core 12, or the flat side 8b, is however covered by a second cover layer 26 in this case. The flat side 8b is thus coated entirely, or surface-wide, by the second cover layer 26. The entire area of the flat side 8b thus forms the coating region 20 for the second cover layer 26. There is no free region 22 in respect of the second cover layer 26.

This side of the sandwich component 2, or the flat side 8b, is in this case a visible side 40, i.e. when the sandwich component 2 is installed as intended in the eVTOL aircraft, it is visible to passengers from an interior (not represented) of the aircraft. Passengers inside the eVTOL can thus look at this visible side 40. This visible side 40 is therefore covered surface-wide with the second cover layer 26 in order to impart a visually appealing appearance of the sandwich component 2.

The second cover layer 26 is thus an extensive prepreg ply, which is also drawn over corners and edges, as is known from the art for interior paneling components.

FIG. 2 also indicatively shows a flowchart of a method for producing the sandwich component 2: in the method, the core 12 is provided in a step S1. In a subsequent step S2, at least one of the flat sides 8a,b, in this case the flat side 8a, is coated with the first cover layer 14a in such a way that the core 12 remains accessible from the environment 24 in the free region 22 on this flat side 8a.

FIG. 3 shows a symbolic cross section through the sandwich component 2 along the line III-III in FIGS. 1 and 2. In this case, the way in which the core 12 is only partially coated with the first cover layer 14a on its first flat side 8a, so as to form the coating region 20 and the free region 22, may again be seen. On the flat side 8b, conversely, the core 12 is coated so as to cover its surface, i.e. entirely, by the second cover layer 26.

FIG. 3 therefore shows a structure with 6 mm of honeycomb and UD strips: the second cover layer 26 is a prepreg (lattice construction), and the core 12 is a 6 mm thick honeycomb component.

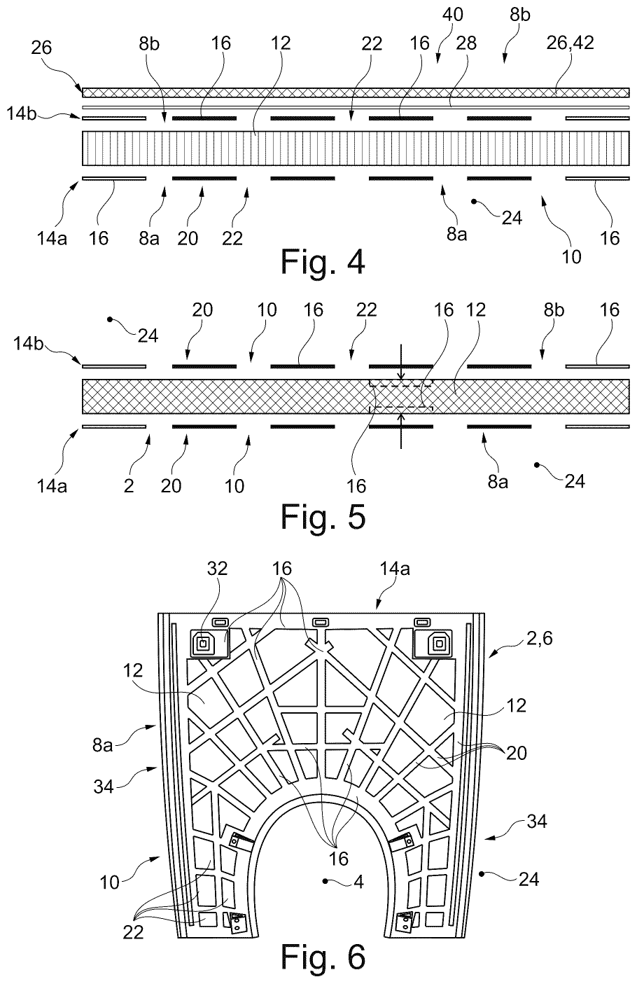

FIG. 4 shows in cross section an alternative embodiment of a sandwich component 2, which corresponds to the first exemplary embodiment according to FIGS. 1-3 in respect of the core 12 and the first flat side 8a as well as the coating thereof by the first cover layer 14a.

In this case, however, a first cover layer 14b corresponding to the first cover layer 14a is initially also applied on the second flat side 8b. Only then, by using an adhesive film 28, is the second cover layer 26b applied as a top layer so that it fully covers both the core 12 and the first cover layer 14b.

FIG. 4 therefore shows a construction with 6 mm of honeycomb and a thin foam ply: the construction corresponds to that of FIG. 3, but the second cover layer 26 is formed by a foam component 42. This is necessary since the core in the form of the honeycomb component cannot be decorated (open honeycomb).

FIG. 5 shows a further alternative exemplary embodiment of a sandwich component 2. In the intended installed state in the eVTOL, it does not have a visible side 40, i.e. it cannot be seen by passengers. Its external appearance is therefore unimportant, for which reason it does not contain a second cover layer 26. In this case, only a first cover layer 14a,b according to the preceding exemplary embodiments is respectively applied onto the two flat sides 8a,b of the core 12. Unlike above, the core 12 is furthermore not a honeycomb core in this case, but instead but a foam core. It has a closed surface and can itself therefore already be decorated.

FIG. 6 shows a rear side 10 of a further alternative sandwich component 2, which corresponds to the principle of the embodiment according to FIGS. 1-3, but in this case a different structure of the first cover layer 14a is constructed with alternative fiber components 16. The framework 34, or its configuration, is thus selected alternatively in this case.

The framework 34 is in this case a unidirectional pattern laid in a network and made with tapes. The component marginal region (margin 30) is reinforced with textile prepreg on the rear side 10. In general, regular patterns (not represented in this case) are also possible (triangles, squares, etc.).

In all exemplary embodiments, not only the first cover layers 14a,b but also the second cover layers 26 are each formed as a single ply. This means that only one ply of fiber components 16 is laid on the core 12 both for each of the first cover layers 14a,b and for each of the second cover layers 26. Intersections 36 or branchings 38 (indicated by way of example in the framework 34) of fiber components 16 are excepted from this. Although two or three fiber components 16 may possibly also lie above one another locally in this case, this relates only to small lengthwise sections of the respective fiber components 16. Therefore, the term “single-ply” embodiment is nevertheless used in this case.

FIGS. 3, 4 and 5 are to be interpreted as diagrammatic illustrations in the form of an exploded representation/rectified representation. In fact, the respective first cover layers 14a,b are formed flush with the core 12, which is indicated by dashed lines and arrows in FIG. 5 for two of the fiber components 16. The core 12 is locally compressed slightly at the site of the fiber components 16, so that the fiber component 16 is sunk or pressed into the latter during production (direction of the arrows).

The following is a summary list of reference numerals and the corresponding structure used in the above description of the invention:
2 sandwich component
4 window
6 paneling component
8a,b flat side
10 rear side
12 core
14a,b first cover layer
16,a,b,c, . . . fiber component
18 fiber
20 coating region
22 free region
24 environment
26 second cover layer
28 adhesive film
30 margin
32 coupling element
34 framework
36 intersection
38 branching
40 visible side
42 from component
S1,2 step

1. A sandwich component, comprising:
a core having two opposite flat sides;
at least one first cover layer connected to said core, said at least one first cover layer mechanically stabilizing the sandwich component and containing at least one fiber component containing fibers;
at least one of said flat sides being coated with said first cover layer, in such a way that:
only a coating region of said at least one flat side is covered by said at least one first cover layer, leaving a remaining uncoated free region of said at least one flat side, and
said at least one flat side is not coated with any further layers, rendering said core accessible from the environment in said free region on said at least one flat side.

2. The sandwich component according to claim 1, wherein said coating region occupies at least 10% and at most 50% of a total area of a respective flat side.

3. The sandwich component according to claim 1, wherein said at least one fiber component includes at least one fiber component exclusively having unidirectionally oriented fibers.

4. The sandwich component according to claim 1, wherein said at least one fiber component includes at least one fiber component having crossed fibers.

5. The sandwich component according to claim 4, wherein said at least one fiber component having crossed fibers is disposed on a margin of a respective flat side.

6. The sandwich component according to claim 4, which further comprises at least one mechanical coupling element firmly mechanically connected to a remainder of the sandwich component, and said at least one fiber component having crossed fibers is associated with said coupling element.

7. The sandwich component according to claim 1, wherein said at least one fiber component includes at least one fiber component configured as tape.

8. The sandwich component according to claim 7, wherein said at least one first cover layer includes a plurality of first cover layers, and at least a part of at least one of said plurality of first cover layers is formed by fiber components formed as tape, said fiber components formed as tape being disposed in a shape of a framework on a respective flat side.

9. The sandwich component according to claim 1, wherein said at least one first cover layer includes a plurality of first cover layers, and at least a part of at least one of said plurality of first cover layers is formed of said fiber components in one ply.

10. The sandwich component according to claim 1, wherein said at least one first cover layer includes a plurality of first cover layers, and at least a part of at least one of said plurality of first cover layers is formed flush with said core.

11. The sandwich component according to claim 1, which further comprises a second cover layer coating at least one of said flat sides.

12. The sandwich component according to claim 11, wherein at least one of said flat sides is covered surface-wide by said second cover layer.

13. The sandwich component according to claim 12, wherein said at least one of said flat sides being coated surface-wide by said second cover layer is a visible side of the sandwich component in an intended mounting state of the sandwich component.

14. The sandwich component according to claim 11, wherein said second cover layer is one of a plurality of second cover layers, and at least one of said plurality of second cover layers contains a foam component.

15. A method for producing the sandwich component according to claim 1, the method comprising:
providing said core; and
coating at least one of said flat sides with said first cover layer while causing said core to remain accessible from the environment in said free region on said flat side.
